(19) United States
(12) Patent Application Publication
(10) Pub. No.: US 2006/0067311 A1
(43) Pub. Date: Mar. 30, 2006

(54) Method of processing packet data at a high speed

(75) Inventor: Yoshihisa Ogata, Tokyo (JP)

Correspondence Address: NIXON PEABODY, LLP, 401 9TH STREET, NW, SUITE 900, WASHINGTON, DC, 20004-2128, US

(73) Assignee: Oki Electric Industry Co., Ltd., Tokyo (JP)

(21) Appl. No.: 11/195,745

(22) Filed: Aug. 3, 2005

(30) Foreign Application Priority Data
Sep. 30, 2004 (JP) 2004-287485

(51) Int. Cl. H04L 12/50

(52) U.S. Cl. 370/371

(57) ABSTRACT

To provide a packet processing method which is able to prevent data loss to transfer data fast, a communications system includes a FIFO buffer that stores received packet data and a cache memory that caches the received packet data stored in the FIFO buffer. After storing the received packet data in the FIFO buffer, a hardware interrupt request and a software interrupt request are generated under the control of MAC protocol software. The received packet data are in turn transferred from the FIFO buffer to the cache memory in response to the hardware interrupt request. After the transfer has been finished, the received packet data are transferred from the cache memory to upper protocol software in response to the software interrupt request.

### BACKGROUND FOR THE INVENTION

1. Field of the Invention

The present invention relates to a method of processing packets on a high-speed local area network (LAN), and more particularly to a method of processing data stored in a buffer at a high speed.

2. Description of the Background Art

Realization of the idea for connecting plural computers each other begun with the inauguration of a network named “Ethernet” (trademark) by Xerox Corporation, U.S.A., in 1975. The network was standardized as IEEE 802.3, IEEE (Institute of Electrical and Electronics Engineers, Inc.) international standards, in 1975. The standard, IEEE 802.3, enriches the functions of the physical layer, data link layer and MAC (Medium Access Control) layer of a network, and adopts CSMA/CD (Carrier Sense Multiple Access with Collision Detection) system as a communications system that provides equal communicating opportunities to all computers connected to the network.

Today, Ethernet has grown rapidly popular, and its communication speed has developed from 10 Mbit/s to 100 Mbit/s, further Gigabit Ethernet (trademark) is realizing now. Thus, to deal with high-speed data communications, the necessary processing ability of protocol software for the MAC layer has been increased more and more. Especially, for the processing to store communication packets received over a network in a FIFO (First-In First-Out) buffer and transfer the stored data to an upper-layer protocol, high-speed processing is required to prevent data loss.

At present, among IP protocols running over the Ethernet, the TCP (Transmission Control Protocol) protocol is most general, and is very reliable as it is able to provide connection-type communications.

A control flow will be described until a TCP communication connection is established. At the first step, one host, A, transmits signal “SYN” to another host, B. At the second step, responding to it, the host B transmits signals “ACK+SYN” to the host A. At the third step, the host A sends out a signal “ACK” as a response to the signal “SYN” back to the host B. At this point of time, a TCP communication link is established and a communication becomes available between both hosts. Like this, in a TCP communication, by acknowledging the response “ACK” for data transmission a reliable communication is achieved. A parameter that is used to define the possibility to communicate without waiting for this signal “ACK” is the window size (in the unit of segment).

When the window size is “1” (segment), a communication between the hosts A and B goes on as follows: The host A waits for the response “ACK” transmitted from the host B, and thereafter it sends out next data. When the window size is “5”, without waiting for the response “ACK” to be transmitted from the host B, the host A can send out data five times consecutively. Therefore, the window size affects very much the throughput (effective communication speed) of TCP communication. It is therefore preferable to set the window size as large as possible, considering the trade-off between other processing and the quality of channel.

In Japanese patent laid-open publication No. 155010/1998, a packet processing method and a network architecture are disclosed wherein a connection is established between nodes of a network and received packets stored in a receiving buffer are processed in the order of protocols from the lower to the upper layer.

In Japanese patent laid-open publication No. 2000-332817, a packet processing method is disclosed for processing a hierarchized communications protocol. Further, in international publication No. WO 00/13091, published on Mar. 9, 2000, an intelligent network interface device and a system for accelerating communication are disclosed.

For example, in a LAN system of low processing ability that uses a low-speed processor, however, such a situation may occur that the processing speed cannot follow up the incoming speed of Ethernet frames to be stored in the FIFO buffer on a 100 Mbit/s transmission. For example, if the window size is set with more than “1”, the data sent out after the first data from the host A would be lost without being normally processed at the host B. Then, necessary re-transmission of lost data results in deterioration of the throughput, which would be a difficulty.

It is an object of the invention to provide a packet processing method that is able to accomplish high-speed data transfer by preventing data loss.

In accordance with the present invention, in a communications system including a first memory that stores received packet data and a second memory that caches the received packet data stored in the first memory, a method comprises the steps of storing the received packet data in the first memory in response to a write signal, generating a hardware interrupt request and a software interrupt request in response to the write signal under the control of MAC protocol software, transferring the received packet data from the first memory to the second memory in response to the hardware interrupt request, and transferring, after the step of transferring, the received packet data from the second memory to upper protocol software in response to the software interrupt request.

Further in accordance with the invention, comprises in a communications system including a first memory that stores received packet data, a second memory that caches the received packet data stored in the first memory and a third memory working as a main memory, a method comprises the steps of storing the received packet data in the first memory in response to a write signal, generating a hardware interrupt request and a software interrupt request in response to the write signal under the control of MAC protocol software, transferring the received packet data from the first memory to the second memory in response to the hardware interrupt request, and transferring, while the received packet data remain in the second memory, the received packet data from the second memory to the upper protocol software in response to the software interrupt request after the step of transferring, and transferring, when the received packet data are driven out from the second memory to the third memory, the received packet data, driven out from the second memory to the third memory, from the third memory to the upper protocol software in response to the software interrupt request after the step of transferring.

With a configuration according to the invention, after storing received packet data in the first buffer in response to the write signal, the hardware interrupt request and the software interrupt request are generated in response to the write signal, the received packet data are then transferred from the first memory to the second memory in response to the hardware interrupt request, and, after the transfer has been finished, the received packet data are transferred from the second memory to the upper protocol software in response to the software interrupt request. Data are thereby transferred from the intermediate queue to the upper layer, thus there being a marginal time for data transfer. The received data can therefore be processed sufficiently under the interrupt control working in a real-time operating system. By means of the interrupt handler controlled by the fast interrupt request (FIQ), the received packet data are transferred to the intermediate queue in the second memory, thus preventing data loss, as well.

In an original duplicate interrupt system of the invention wherein an ordinary interrupt request (IRQ) and a fast interrupt request (FIQ) are simultaneously generated, direct high-speed transfer is established by means of a central processor unit. As a result, in TCP communications, when the window size is set larger than “2” (segments) a stable and high-speed processing can be carried out for e.g. 100 Mbit/s LAN communications.

### BRIEF DESCRIPTION OF THE DRAWINGS

The objects and features of the invention will become more apparent from consideration of the following detailed description taken in conjunction with the accompanying drawings in which:

FIG. 1 schematically shows an exemplified configuration for fast task processing in a communications system of according to an embodiment of the invention;

FIG. 2 is useful for understanding a buffering operation of the intermediate queue of the embodiment shown in FIG. 1;

FIG. 3 is also useful for understanding a consecutive buffering operation of the intermediate queue of the embodiment;

FIG. 4 also schematically shows a conventional configuration for task processing in a communications system;

FIG. 5 is a sequence chart useful for understanding an example of TCP data communication; and

FIG. 6 is a sequence chart, like FIG. 5, useful for understanding a situation wherein data loss occurs in a TCP data communication.

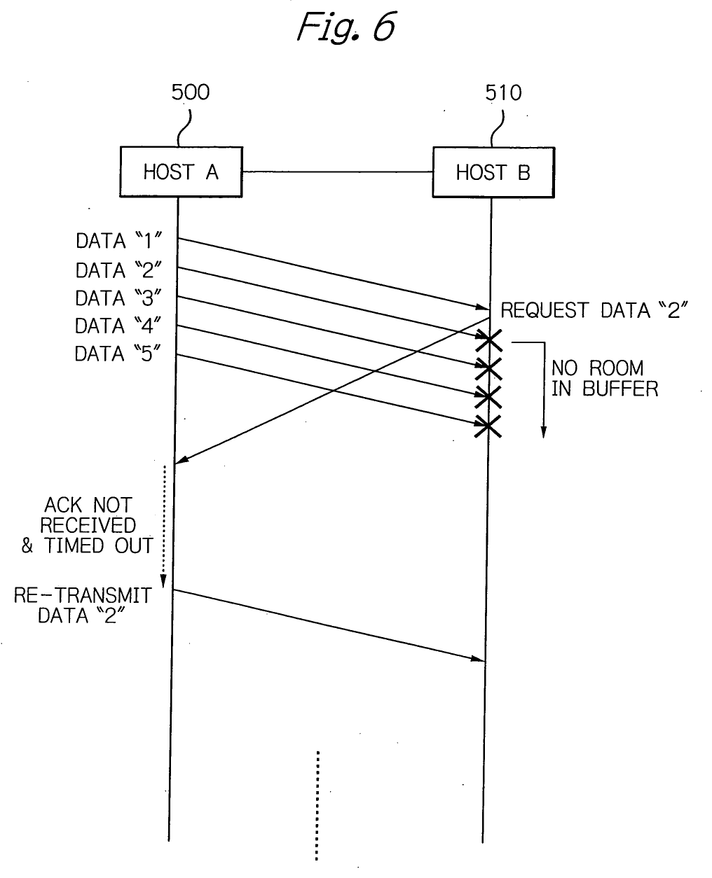

### DESCRIPTION OF THE PREFERRED EMBODIMENT

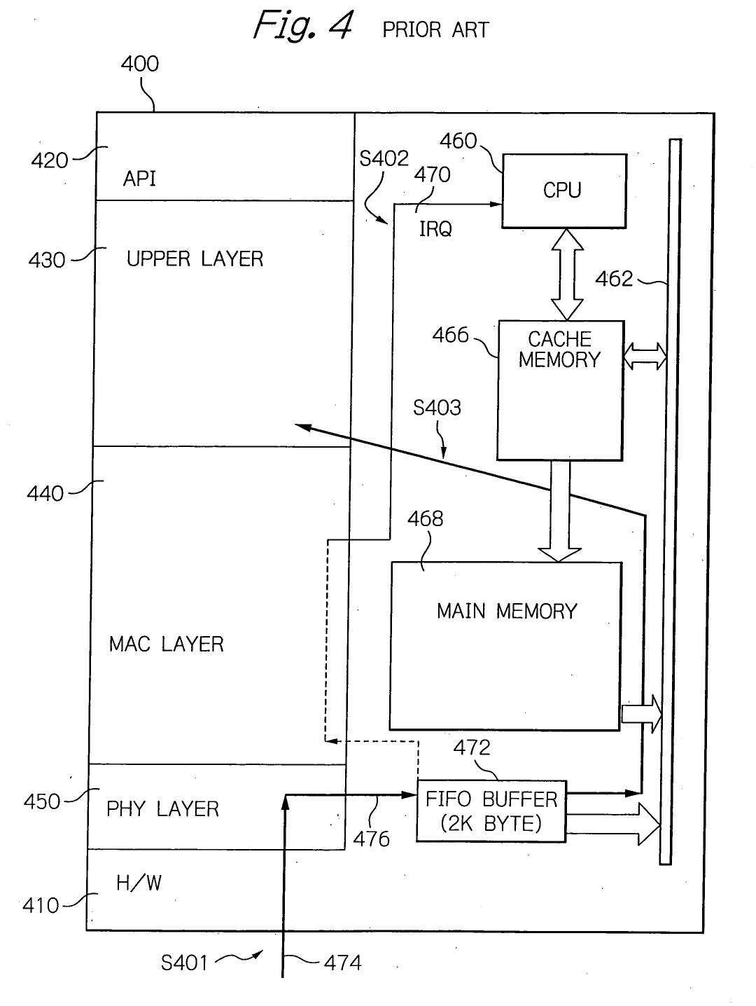

In the following, a preferred embodiment of the invention will be described in detail in reference to the accompanying drawings. Before the description of the embodiment, an example of the conventional configuration will first be described in reference to FIG. 4. FIG. 4 shows a typical configuration of a communications system 400 interconnected to a local area network (LAN) system consisting of personal computers, etc.

The exemplified configuration, which is in the form of a stack of communication protocols, consists of hardware (H/W) 410, in which part of the hardware components of the communications system 400 is included as illustrated. The communication protocol stack comprises an application layer (API) 420, an upper layer 430 such as TCP/IP (Transmission Control Protocol/Internet Protocol), etc., a MAC (Medium Access Control) layer 440, which is a part of data link layer, and a physical (PHY) layer 450. Among these layers, the MAC layer 440 and the physical (PHY) layer are significantly in connection with the processing of communication packets. In the hardware (H/W) 410, a central processor unit (CPU) 460 plays the role of central processing system, and a cache memory 466 and a main memory 488 are connected to a data bus 462. The processor 460 has, for example, an RISC (Reduced Instruction Set Computer) type of processor core such as “ARM7TDMI” (trademark) and includes a primary cache memory and an interrupt control circuit, not specifically shown.

In this conventional system, the processor 460, including an interrupt control function, has its input terminal to receive an ordinary interrupt request (IRQ) signal 470. The interrupt request (IRQ) signal 470 is usually generated as a software interrupt request and works under the control of the operating system (OS) of the processor 460.

Usually, the cache memory 466 is composed of relatively high-speed memories like an SRAM (Static Random Access Memory), and the main memory 468 is composed of low-speed memories like a DRAM (Dynamic Random Access Memory). The FIFO (First-In First-Out) buffer 472 temporarily stores a data frame 476 taken out from the received communication packet. In the following, signals are designated with reference numerals denoting connections on which they are conveyed.

Next, it will be described how to deal with a communication packet in this conventional system. As shown in FIG. 4, by means of the hardware 410 the data frame 476 is taken out from the communication packet 474 addressed to a certain device over a wired LAN, and the data frame 476 is stored into the FIFO buffer 472, step S401 in the figure. The data frame 476, forming a communication packet, contains from 64 to almost 1,500 bytes of data according to the IEEE 802.3 standard. The data frame 476 has its header including a vender identification (ID) and/or a device number field. The vender identification and device number are discriminated by the hardware 410 to determine whether or not the packet in question is addressed to the subject system. If the packet is not addressed to the system, it is then discarded without being stored in the FIFO buffer 472. The FIFO buffer 472, having its storage capacity of 2 k bytes, for example, temporarily stores the received frame data.

After having written in the data frame 476 to the FIFO buffer 472, the interrupt request (IRQ) signal for interrupting the processor 460 is generated by the protocol software of the MAC layer, step S402. The generated IRQ signal is inputted to the processor 460.

The IRQ signal boots up an associated interrupt handler, not shown, so that the received data stored in the FIFO buffer 472 are read out and then transferred to the upper layer 430, step S403. However, if another interrupt process having its priority higher than the IRQ request is proceeding, the above-described process has to wait until the other interrupt process in question is completed.

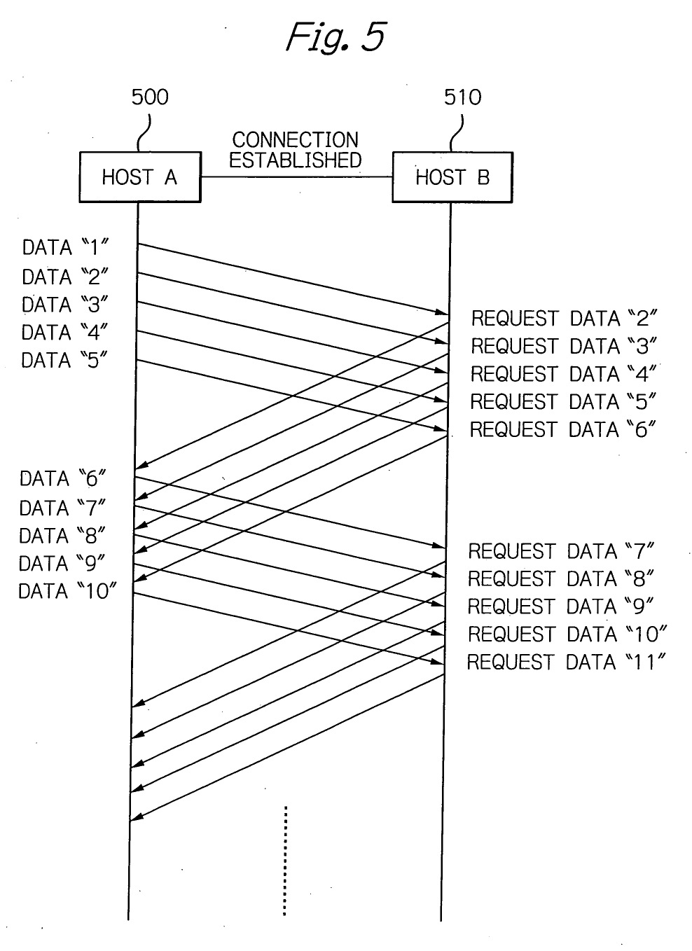

Now, one of the conspicuous problems encountered in the conventional system will be described in reference to FIG. 5, in the case where a TCP frame having its size of 1,500 bytes is sent from one host, A, to another host, B, and the window size is “5” (segments). As shown in FIG. 5, the one host, A, 500 sends out data “1” through “5” consecutively according to the communication speed, or transmission rate. Thereafter, the one host 500 confirms the receipt of an acknowledgement signal “ACK” in respect to the data “1” by the other host 510, and thereafter it transmits data “6”. Similarly, the one host 500 in turn confirms the receipt of a signal “ACK” in respect of the data “2”, and thereafter it sends out data “7”. In that manner, the host 500 transmits the following data each time having confirmed the receipt of a signal “ACK” from the other host 510. This is the normally expected operation.

In a built-in system implemented by a processor having its processor speed relatively low, the above-described operation is possible for low-speed communications of 10 Mbit/s. For communications of, e.g. 100M/s, however, the processing speed of the upper layer 430 of such a built-in system cannot catch up with the receiving speed of Ethernet frames stored in the FIFO buffer 472, FIG. 4. Therefore, when the window size is set more than “1”, at the point of time when the first data have been received, the capacity of the FIFO buffer 472 becomes short to fill the length of a received frame, so that the FIFO buffer 472 cannot store the data received after the first data. As a result, data will be lost. Thus, the one host 500 cannot receive a signal “ACK” acknowledging the receipt of the second transmitted packet so that time-out occurs and the one host 500 goes to re-transmit the second data. Such a phenomenon could have been repeated eternally, and the resulting throughput deterioration becomes a problem.

The above-described example is an extreme case in which the TCP transmission data have the length thereof maximum to 1,500 bytes. For example, if the TCP transmission data have the length thereof minimum of the Ethernet frame, i.e. 64 bytes, the FIFO buffer has sufficient room at the time of starting transmission, so that re-transmission is not required for the time being. However, as the receiving rate is higher the processing speed, the FIFO buffer may be filled up eventually, and at that time re-transmission will be required.

As described above, in the conventional system shown in FIG. 4, when the incoming speed of the data frame 476 of the receiving data exceeds the speed of transferring the stored data frames to the upper layer, the difficulty would occur.

Now, an embodiment according to the present invention will be described in which a new solution is introduced which uses a cache memory and a fast interrupt request (FIQ) to cause a central processor to transfer data. In this new solution, when the FIFO buffer 116 has been filled up, an ordinary IRQ signal and a fast interrupt request (FIQ) signal are simultaneously generated, and respective interrupt handlers associated therewith are used to store received data, an intermediate queue being used as a buffer memory. Further, the FIFO buffer has a double-buffer structure different from the prior art.

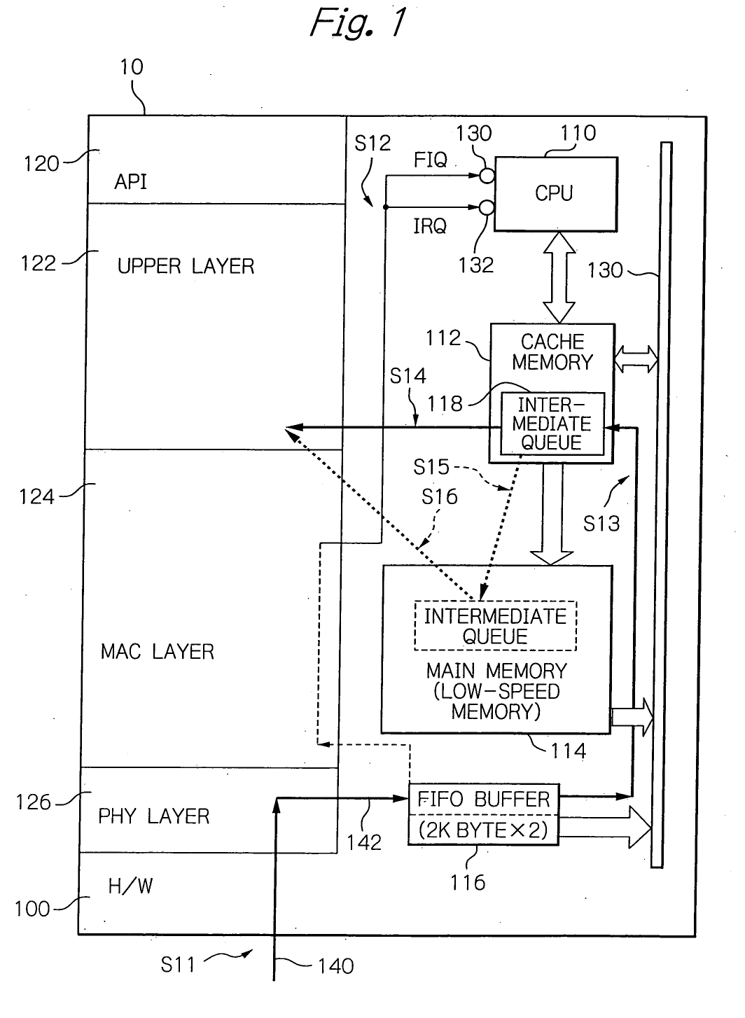

In FIG. 1, the configuration of high-speed task processing in the communications system is shown according to the illustrative embodiment. As a whole, the configuration of the FIG. 1 embodiment is in the form of a stack of communication protocols, and includes hardware (H/W) 100 comprising part of hardware components of a communications system 10.

The communications system 10 of the embodiment comprises the hardware (H/W) 100 which consists of a central processor unit (CPU) 110, a cache memory 112, a main memory 114 and a buffer memory 116, etc. The system 10 further includes software consisting of application program sequences, a real-time operating system (OS), communication drivers and a stack of communication protocols, etc., which are stored in the main memory 114 when running. The communication protocol stack comprises, downward from the top layer, an application (API) layer 120, an upper layer 122 such as TCP/IP protocols, a MAC layer 124, which is part of a data link layer, and a physical (PHY) layer 126. Among those layers, the MAC layer 124 and the physical layer 126 predominantly real with processing communication packets. In the hardware (H/W) 100 of the communications system 10, the central processor 110 functions as a main control, and a cache memory 112 and a main memory 114 are interconnected to a data bus 130. The processor 110 has, for example, an RISC type of processor core such as “ARM7TDMI” (trademark), and includes a primary cache and an interrupt control circuit, not specifically illustrated.

In the communications system 10, the cache memory 112 is provided with an intermediate queue 118, which is saved during caching, by means of protocol software of the MAC layer 124. The illustrative embodiment is exemplified as a communications system configuration using the cache memory 112 together with the main memory 114 with the cache memory 112 working as an external cache of the processor 110 to thereby increase the processing speed.

In the embodiment, the processor 110 is provided with an interrupt control function. The processor 110 has its input terminal 130 to receive an ordinary IRQ signal and its input terminal 132 to receive a fast interrupt request (FIQ) signal. Both interrupt signals have the priority thereof prescribed respectively. The FIQ signal is usually a hardware interrupt request having its priority higher than the IRQ request, and is fast. The IRQ request is usually a software interrupt request, and works under the control of the operating system. Therefore, the IRQ signal is lower in speed than the FIQ signal, which works out of the control of the operating system. Although being lower, for a conventional low-speed, e.g. 10 Mbit/s, of Ethernet communications, only the IRQ request is employed to the extent that packets can sufficiently be processed without being lost.

The cache memory 112 is usually composed of high-speed memory such as an SRAM. With the embodiment, the cache memory 112 is provided therein with the intermediate queue 118. The intermediate queue 118 is under the control of the protocol software of the MAC layer 124. The intermediate queue 118 is usually composed of a high-speed memory such as an SRAM. The FIFO buffer 116 is adapted for temporarily storing data frames 142 taken out from a received communication packet 140. The FIFO buffer 116 of the embodiment is composed of two FIFO storage areas, each of which has its storage capacity of 2 k bytes, and is adapted to alternately store a frame of data 142 transferred from the physical layer 126 into the couple of storage areas.

Well, it will be described how to deal with communication packets in the communications system having the above-described configuration. By means of the hardware 100 a frame of data 142 is taken out from a communication packet addressed to a certain device over a wired LAN, and in turn stored into one of the FIFO storage areas of the FIFO buffer 116, step S11. The data frame 142 forming the communication packet contains, for example, data having 64 to almost 1,500 bytes in the 100 Mbit/s Ethernet according to the IEEE 802.3 standard. The data frame 142 has its header comprising vender identification (ID) and/or device number fields. The vender identification and device number contained in the respective fields are discriminated by the hardware 100 so that, if the received packet is not addressed to the instant system 10, it is then discarded without being stored in the FIFO buffer 116. The frame of data addressed to the instant communications system will be stored alternately in one or the other storage area of the FIFO buffer 116. The data would not be stored in the order different from when received.

After the frame of data has been written in the FIFO buffer 116, an interrupt request signal to the processor 110 is responsively generated by the protocol software of the MAC layer 124, step S12. In the embodiment, a duplicate interrupt system is employed wherein an ordinary IRQ signal and a fast interrupt request (FIQ) signal are simultaneously generated. The reason therefor is a way of buffering received data, which will be described below. The FIQ signal has its priority highest within this system. Therefore, the corresponding interrupt handler is adapted to start immediately to allow the received data stored in the FIFO buffer 116 to be transferred to the intermediate queue 118 provided in the cache memory 112 over the data bus 130, step S13. The transfer is directly made under the control of the processor 110, and a control scheme such as a multiple transfer instruction is also usable so that the transfer is processed very fast.

More specifically, whenever data have been written into the FIFO buffer 116, the data are immediately transferred to cause the FIFO buffer 116 to be empty. It will thus be able to afford to receive following packets incoming consecutively. After the transfer of the data, buffering is done in respect of the intermediate queue 118, and the data set on the intermediate queue 118 will be transferred to the upper layer 122, step S14.

In an application employing a write-back cache memory access system, however, if there occur so many accesses beyond the cache memory capacity, the data will be swept off from the cache memory 118 to the main memory generally by means of an LUF (Least Frequency Used) algorithm under the control of the cache controller, step S15. In this case, the upper layer 122 is not adapted to obtain data from the cache memory 112, but required to make an access to the data swept off from the cache memory 112 to the main memory 114.

Therefore, when the protocol software of the MAC layer 124 tries to obtain from the intermediate queue 118 data which are actually not contained in the cache memory 112, it will obtain appropriate data from the main memory 114, step S16.

Although the above-described processing uses the main memory 114, it is executed by the protocol software of the MAC layer 124 caused by the interrupt handler adapted for responding to the IRQ request, thus being able to afford to execute.

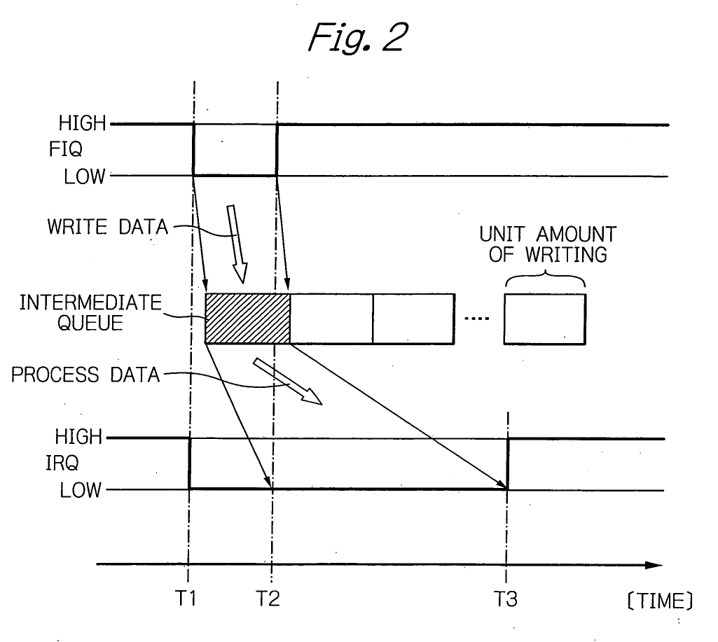

Next, the buffering of the intermediate queue 118 adopted in the embodiment will be described below. FIG. 2 shows how the intermediate queue of the embodiment works. It will be described how the queue buffering proceeds as time goes on. In the duplicate interrupt system using FIQ and IRQ signals adopted in the embodiment, when the FIQ and IRQ signals take the lower logical value L thereof, the corresponding interrupt handlers will be booted up. However, the FIQ request has its higher priority than the IRQ request, only the interrupt handler associated with the FIQ request is booted up, while the interrupt handler associated with the IRQ request has to wait to be booted up at the time T1.

In the embodiment, the unit amount of data to be written is 2 k bytes, which are substantially equal to the storage capacity of the FIFO buffer 116. The transfer of data to the cache memory 112 is executed in the form of direct data transfer under the control of the processor 110, thus being very fast and finished in a short time. After the transfer has been finished to release the FIQ request, then the interrupt handler associated with the IRQ request, waiting, will be booted up at the time T2. The interrupt handler responding to the IRQ request transfers all data contained in the intermediate queue 118 to an application program, etc., included in the API layer 120 via the upper layer 122 at the time T3. Although that transfer process is also the direct data transfer under the control of the processor 110, it is done under the control of real-time operating system, etc., thus lowering the transfer speed as a whole due to the consumption of time for linking, etc. Even when the processing is done with relatively lower speed, none of data will be lost.

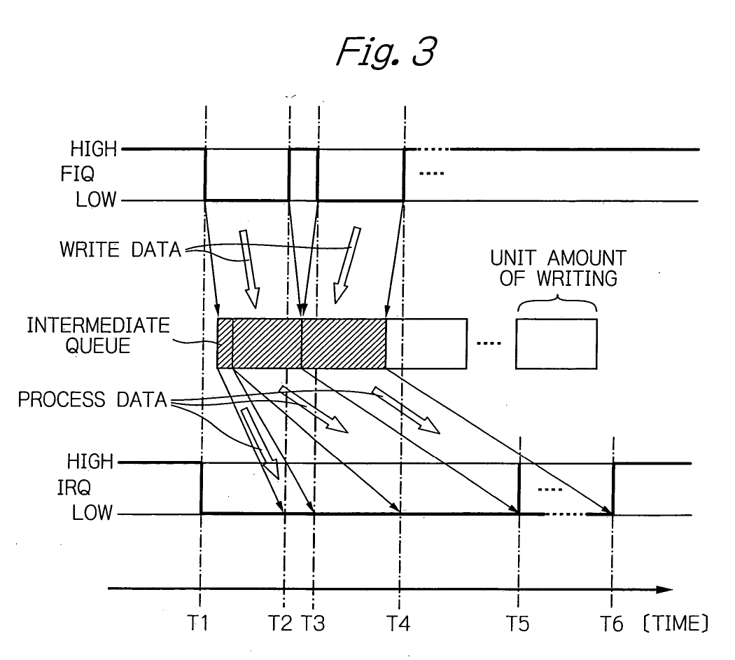

It will be described below how the intermediate queue 118 acts as buffering when packets addressed to the system are consecutively being received without having finished the previous transfer by the IRQ request to generate a new request to transfer them by a new FIQ request, i.e. a multiple interrupt. The consecutive buffering operation of the intermediate queue 118 is understandable from FIG. 3. In the figure, the first receiving interrupt request has occurred at the time T1, and thereafter the interrupt handler by the IRQ request starts transferring the written data to an application program, etc., at the time T2. After that, the second receiving interrupt request is generated at the time T3, the processing of the interrupt handler by the IRQ request is adjourned due to the higher priority of the FIQ request at this point of time. Consequently, while the processing of the first received data has not been finished yet, the following data are accumulated in the intermediate queue without being processed. When the data transfer by the second receiving interrupt request has been finished, the data processing of the interrupt handler by the IRQ request resumes at the time T4.

This processing continues until the intermediate queue 118 becomes empty without stopping even when the data treated by the first receiving interrupt request have been processed at the time T5. When the data transfer treated by the second receiving interrupt request is finished, the intermediate queue returns to its waiting status for receiving an interrupt request at the time T6.

The data associated with plural packets are thus accumulated in the intermediate queue, requiring the intermediate queue 118 having its storage capacity to a certain extent. It is of course not necessary to provide an excessively large storage capacity but such a suitable capacity as not to incur re-transmission against a defined window size in TCP communications.

In the above, the multi-interrupt processing has been described. Further, when, during an interrupt processing by the IRQ request, another interrupt processing is demanded also by an IRQ request which has however its priority higher than the present interrupt under processing, the interrupt processing may be done by the FIQ request so that the data are prevented from being lost even if the interrupt processing is delayed by another processing. There would thus occur no problem to precede another processing having its priority higher.

Furthermore, there is also no problem to handle the plural IRQ requests kept waiting by the multi-interrupt processing, because the multi-interrupt processing is completed very fast when no data remain in the intermediate queue 118, and then the following processing of the waiting IRQ requests will be rapidly executed.

With the embodiment described above, a computer having a cache memory is provided with an original duplicate interrupt system wherein an ordinary IRQ request and a fast interrupt request (FIQ) are simultaneously generated, thus accomplishing fast and stable high-speed LAN communications of, or exceeding, 100 Mbit/s. Further, the embodiment described above is directed to a computer provided with the function of high-speed wired LAN. The invention can, however, be applied not only to a wired LAN but to a wide range of wired or wireless networks, and also not only to personal computers but also to portable devices such as mobile telephone sets as well.

The entire disclosure of Japanese patent application No. 2004-287485 filed on Sep. 30, 2004, including the specification, claims, accompanying drawings and abstract of the disclosure is incorporated herein by reference in its entirety.

While the present invention has been described with reference to the particular illustrative embodiment, it is not to be restricted by the embodiment. It is to be appreciated that those skilled in the art can change or modify the embodiment without departing from the scope of the present invention.

What is claimed is:

1. A method of processing packets in a communications system including a first memory for storing received packet data and a second memory for caching the received packet data stored in the first memory, comprising the steps of:
storing the received packet data in the first memory in response to a write signal under control of MAC protocol software;
generating a hardware interrupt request and a software interrupt request in response to the write signal;
transferring the received packet data from the first memory to the second memory in response to the hardware interrupt request; and
transferring, after said step of transferring, the received packet data from the second memory to upper protocol software in response to the software interrupt request.

2. The method in accordance with claim 1, further comprising the steps of:
adjourning, whenever both of the hardware interrupt request and the software interrupt request are generated a plurality of times in response to the write signal, said step of transferring in response to the software interrupt request, and executing said step of transferring in response to the hardware interrupt request; and
restarting, after said step of transferring in response to the hardware interrupt request has been finished, said adjourned step of transferring in response to the software interrupt request.

3. The method in accordance with claim 1, wherein the first memory is a FIFO (First-In First-Out) memory.

4. The method in accordance with claim 2, wherein the first memory is a FIFO (First-In First-Out) memory.

5. A method processing packets a communications system including a first memory for storing received packet data, a second memory for caching the received packet data stored in the first memory and a third memory working as a main memory, comprising the steps of:
storing the received packet data in the first memory in response to a write signal under control of MAC protocol software;
generating a hardware interrupt request and a software interrupt request in response to the write signal;
transferring the received packet data from the first memory to the second memory in response to a hardware interrupt request;
transferring, while the received packet data remain in the second memory, the received packet data from the second memory to upper protocol software in response to the software interrupt request after said step of transferring; and
transferring, when the received packet data are already driven out from the second memory to the third memory, the received packet data, driven out from the second memory to the third memory, from the third memory to the upper protocol software in response to the software interrupt request after said step of transferring.

6. The method in accordance with claim 5, wherein the first memory is a FIFO (First-In First-Out) memory.

7. The method in accordance with claim 5, wherein the second memory is a write-back cache memory.
